(19) United States
(12) Patent Application Publication
(10) Pub. No.: US 2010/0255249 A1
(43) Pub. Date: Oct. 7, 2010

(54) FILM AND PROCESS FOR PRODUCING THE SAME

(75) Inventors: Junichi Yamanouchi, Kanagawa (JP); Machiko Yamanouchi, Kanagawa (JP); Masaki Noro, Kanagawa (JP); Hidekazu Yamazaki, Kanagawa (JP); Hideaki Naruse, Kanagawa (JP); Shintaro Washizo, Tokyo (JP); Koju Ito, Kanagawa (JP)

Correspondence Address: YOUNG & THOMPSON, 209 Madison Street, Suite 500, Alexandria, VA, 22314, US

(73) Assignee: FUJIFILM CORPORATION, TOKYO (JP)

(21) Appl. No.: 12/680,643

(22) PCT Filed: Sep. 19, 2008
(86) PCT No.: PCT/JP2008/066958

§ 371 Date: Apr. 6, 2010

(30) Foreign Application Priority Data
Sep. 28, 2007 (JP) 2007-255827

(51) Int. Cl. B32B 3/12; B32B 3/26; B05D 3/02

(52) U.S. Cl. 428/116; 428/221; 427/385.5

(57) ABSTRACT

A surfactant is added to a polymer solution (21) which is a coating fluid comprising an organic solvent and a polymer. The surfactant contains a fluorine atom and reduces the surface tension of the coating fluid. The coating fluid (21) is applied to a casting band (26) as a support. Dew condensation is caused to occur on the surface of the polymer film (40) formed by coating fluid application. The organic solvent and droplets are vaporized to thereby cause droplets to come into the film and form voids. By the use of the polymer solution (21), which comprises a mixture of an organic solvent, a polymer, and a fluorine-atom-containing surfactant for surface tension reduction, a structure having such fine pores is formed and a film (12) of a honeycomb structure is obtained. This film is reduced in the adhesion of dust, etc. and has an even micropore structure

### TECHNICAL FIELD

The present invention relates to a honeycomb porous film by use of self-organization, and a method for manufacturing the honeycomb porous film.

### BACKGROUND ART

In recent years, demand for improvement in packing density, memory density, and image definition is more and more increased in an optical field and an electronic field. Also, in a regenerative medical field, a membrane having microporous structure in a surface is useful as a scaffolding material for cell culture (for example, refer to patent document 1). Thus, it is eagerly desired to form microstructure (fine patterning) in a film used in those fields. For the fine patterning, various methods including vacuum evaporation using a mask, an optical lithography technique based on photochemical reaction and polymeric reaction, and a laser ablation technique are in practical use.

It is known that casting a dilute solution of a polymer with specific structure at high humidity can form a microporous film having honeycomb structure of the order of micrometers (for example, refer to patent document 2). This film is the so-called microporous film in which a plurality of micropores are formed in a surface direction. In addition, this honeycomb structure film is used as optical and electronic materials with containing functional impalpable particles. By making the film contain a luminescent material, for example, this film is usable as a display device (for example, refer to patent document 3).

Furthermore, the microporous film is also used in a polarizer. This type of film includes, for example, an antireflection film having moth-eye structure. In this film, an orderly and fine pattern is formed in size of submicrometer to several tens of micrometers. Among a number of pattern forming methods, is dominant a method called a top down method in which a mask or a photomask is produced by using a microfabrication technique based on optical lithography, and a pattern of the mask is transferred to a film (for example, refer to patent document 4).

### Patent Document 1: Japanese Patent Laid-Open Publication No. 2001-157574

### Patent Document 2: Japanese Patent Laid-Open Publication No. 2002-335949

### Patent Document 3: Japanese Patent Laid-Open Publication No. 2003-128832

### Patent Document 4: Japanese Patent Laid-Open Publication No. 2003-302532

### DISCLOSURE OF INVENTION

Manufacturing methods proposed in the patent documents 1 to 3 are simple and available for production of a larger film in principle, but in reality, there is a problem that manufacture at high speed or manufacture of the larger film is likely to cause variations in a surface, in other words, nonuniformity in the surface. A method described in the patent document 4 requires many complex steps for production of the mask, and results in high cost. Also, there is a problem that the mask of a large size is difficult to make.

In the case of using the foregoing microporous film in the optical and electronic fields and the regenerative medical field, adhesion of dust and particles to the film after or during manufacture is seriously undesirable. Thus, is demanded a technique for preventing adhesion of the dust and the particles.

Consequently, the present invention aims to solve the conventional problems described above, and achieve the following object. The object of the present invention is to provide a film that have uniform microporous structure with less adhesion of dust, and a method for continuously or intermittently manufacturing this film of a large size at high speed and low cost.

To achieve the above object, a film of the present invention has microporous structure, and the microporous structure is obtained by an application liquid and a surface-active agent. The application liquid contains an organic solvent and a polymer. The surface active agent contains a fluorine atom, and reduces the surface tension of the application liquid.

It is preferable that the surface-active agent be a fluorine atom-containing polymer made by polymerization of a fluoroaliphatic group-containing monomer. The fluoroaliphatic group-containing monomer is preferably represented by the following general formula (1):

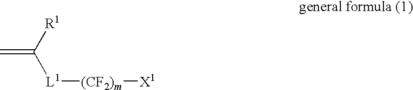

In the general formula (1), R¹ represents a hydrogen atom, a halogen atom, or a methyl group. L¹ represents a divalent linking group, and m represents an integer between or equal to 1 and 12. X¹ represents a fluorine atom or a hydrogen atom.

The additive amount of the surface-active agent is preferably 0.01 to 10 weight % of a total amount. The mass-average molecular weight of the fluorine atom-containing polymer is preferably 2,000 to 100,000. The polymer is at least one type of hydrophobic polymer or amphiphilic polymer. The hydrophobic polymer is preferably at least one of cellulose triacetate, cellulose acetate propionate, and cyclic polyolefin.

The application liquid preferably contains a polyfunctional monomer. The microporous structure is preferably a honeycomb porous structure made by self-organization.

According to the present invention, a method for manufacturing a porous film includes the steps of formulating an application liquid containing an organic solvent and a polymer, adding a surface-active agent that contains a fluorine atom and reduces the surface tension of the application liquid to the application liquid, applying the application liquid to a support material to form an applied film, and forming pores in the applied film to make the porous film by forming liquid drops in the applied film and evaporating the organic solvent and the liquid drops.

It is preferable that the surface tension of the application liquid with the surface-active agent added be 25 mN/m or less. In the pores forming step, the support material having the applied film is preferably passed through a condensation zone to form the liquid drops, and 0° C.≦(TD1−TL)° C. is satisfied in the condensation zone. Wherein, TL(° C.) represents a surface temperature of the applied film, and TD1(° C.) represents a dew point.

It is preferable that air is blown in the condensation zone so that water vapor in the air is condensed to form the liquid drops. The relative speed between the blow speed of the air and the conveyance speed of the applied film is preferably between or equal to 0.02 m/s and 2 m/s. In the pores forming step, the support material having the applied film with the liquid drops formed is preferably passed through a drying zone, and (TL−TD2)° C.≧1° C. is satisfied in the drying zone. Wherein, TD2(° C.) represents a dew point.

According to the present invention, it is possible to continuously or intermittently manufacture a microporous structure film of a large size at high speed and low cost. To the film, dust is less likely to adhere, and the film has uniform microstructure in a surface.

### BRIEF DESCRIPTION OF DRAWINGS

FIG. 1 is a process chart for explaining an example of a film manufacturing method according to the present invention;

FIG. 2 is a schematic view of a film manufacturing apparatus used in the example of the film manufacturing method according to the present invention;

FIGS. 3A to 3D are explanatory views for explaining a film forming method according to the present invention;

FIG. 4 is a plan view of an example of a film according to the present invention;

FIG. 5 is a cross sectional view taken along line V-V of FIG. 4;

FIG. 6 is a schematic view of another example of a film manufacturing apparatus used in the film manufacturing method according to the present invention;

FIG. 7 is a schematic view of further another example of the film manufacturing apparatus used in the film manufacturing method according to the present invention;

FIG. 8 is a schematic view of further another example of the film manufacturing apparatus used in the film manufacturing method according to the present invention;

FIG. 9 is a schematic view of further another example of the film manufacturing apparatus used in the film manufacturing method according to the present invention;

FIG. 10 is a schematic view of further another example of the film manufacturing apparatus used in the film manufacturing method according to the present invention; and

FIG. 11 is a schematic view of further another example of the film manufacturing apparatus used in the film manufacturing method according to the present invention.

### BEST MODE FOR CARRYING OUT THE INVENTION

### Film

A film of the present invention has microporous structure.

The microporous structure is obtained by an application liquid containing an organic solvent and a polymer and a surface-active agent that contains a fluorine atom and reduces the surface tension of the application liquid. The film may include a support material or the like combined as necessary. It is preferable that the microporous structure be honeycomb structure or moth-eye structure formed by self-organization.

(Surface-Active Agent)

The surface-active agent is not specifically limited as long as the surface-active agent can reduce the surface tension of the application liquid, but is preferably, for example, a fluorine atom-containing polymer that is made by polymerization of a fluoroaliphatic group-containing monomer. Containment of the fluorine atom in the surface-active agent is confirmed by elementary analysis such as atomic absorption spectrometry or ICP emission spectrochemical analysis.

The fluoroaliphatic group-containing monomer is not specifically limited, but is preferably, for example, a monomer represented by the following general formula (1).

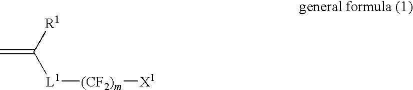

In the general formula (1), R¹ represents a hydrogen atom, a halogen atom or a methyl group, and is preferably the hydrogen atom or the methyl group. L¹ represents a divalent linking group. m represents an integer between or equal to 1 and 12, and is preferably between or equal to 2 and 10, and is more preferably between or equal to 4 and 8, and is the most preferably 4 or 6. X¹ represents a fluorine atom or a hydrogen atom.

The divalent linking group represented by L¹ is not specifically limited, but preferably has structure expressed by the following general formula (2).

(a1)-X¹⁰—R²⁰-(b1) general formula (2)

In the general formula (2), (a1) represents a position bonded to a double bond side, and (b1) represents a position bonded to a fluoroaliphatic group side.

In the general formula (2), X¹⁰ represents a divalent linking group consisting of a single bond or expressed by any of (a2)-COO-(b2), (a2)-COS-(b2), (a2)-OCO-(b2), (a2)-CON(R²¹)-(b2), and (a2)-O-(b2).

Wherein, (a2) represents a position bonded to the double bond side, and (b2) represents a position to be bonded to R²⁰. Among above, (a2)-COO-(b2), (a2)-COS-(b2), or (a2)-CON(R²¹)-(b2) is preferable, and (a2)-COO-(b2) or (a2)-CON(R²¹)-(b2) is more preferable, and (a2)-COO-(b2) is the most preferable.

In the general formula (2), R²⁰ represents a polymethylene group (for example, a methylene group, an ethylene group, a trimethylene group or propylene group) that may have a substituent, a phenylene group (for example, o-phenylene group, m-phenylene group or p-phenylene group) that may have a substituent, or a group formed by arbitrary combination thereof. Among above, the polymethylene group is preferable. In the polymethylene group, the methylene group, the ethylene group, the trimethylene group or a tetra methylene group is preferable, and the methylene group or the ethylene group is more preferable.

R²¹ represents an alkyl group that may have a hydrogen atom or a substituent having a carbon number of 1 to 8, or an aryl group that may have a substituent having a carbon number of 6 to 20. The alkyl group with the hydrogen atom or the substituent having a carbon number of 1 to 6 is more preferable, and the alkyl group with the hydrogen atom or the substituent having a carbon number of 1 to 4 is the most preferable.

Concrete examples of the monomer represented by the above general formula (1) include the following compounds, but are not limited thereto. In a chemical formula 3, F-1 to F-8 indicate combinations between R¹ and m. In a chemical formula 4, F-9 to F-18 indicate combinations among R¹, R³, p and m. In a chemical formula 5, F-19 to F-27 indicate combinations among R¹, p and m. In a chemical formula 7, F-33 to F-44 indicate combinations between R² and n. In a chemical formula 8, F-45 to F-50 indicate combinations among R², R³, q and n. In a chemical formula 9, F-51 to F-56 indicate combinations among R², q and n.

Chemical formula 3:

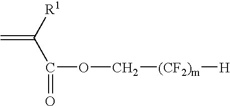

| | R¹ | m |
|---|---|---|
| F-1 | H | 4 |
| F-2 | CH₃ | 4 |
| F-3 | H | 6 |
| F-4 | CH₃ | 6 |
| F-5 | H | 8 |
| F-6 | CH₃ | 8 |
| F-7 | H | 10 |
| F-8 | CH₃ | 10 |

Chemical formula 4:

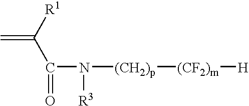

| | R¹ | R³ | p | m |
|---|---|---|---|---|
| F-9 | H | H | 1 | 4 |
| F-10 | CH₃ | H | 1 | 4 |
| F-11 | H | H | 1 | 6 |
| F-12 | CH₃ | H | 1 | 6 |
| F-13 | H | CH₃ | 1 | 6 |
| F-14 | H | H | 1 | 8 |
| F-15 | CH₃ | H | 1 | 8 |
| F-16 | H | CH₃ | 2 | 8 |
| F-17 | H | H | 1 | 10 |
| F-18 | CH₃ | CH₃ | 1 | 10 |

Chemical formula 5:

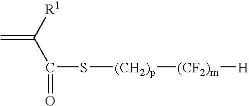

| | R¹ | p | m |
|---|---|---|---|
| F-19 | H | 1 | 4 |
| F-20 | CH₃ | 1 | 4 |
| F-21 | H | 1 | 6 |
| F-22 | CH₃ | 1 | 6 |
| F-23 | CH₃ | 2 | 6 |
| F-24 | H | 1 | 8 |
| F-25 | CH₃ | 1 | 8 |
| F-26 | H | 1 | 10 |
| F-27 | CH₃ | 1 | 10 |

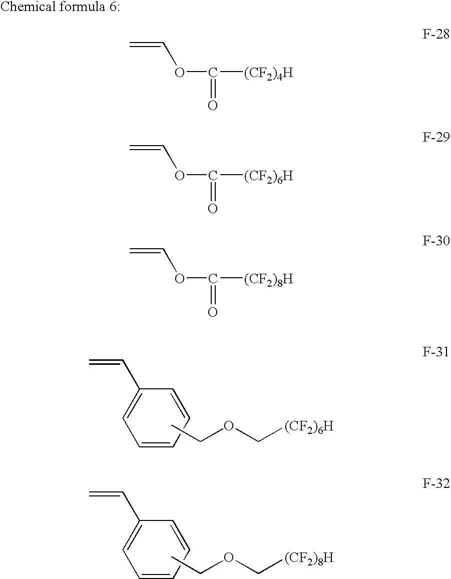

Chemical formula 7:

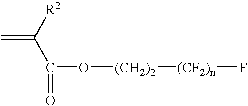

| | R² | n |
|---|---|---|
| F-33 | H | 2 |
| F-34 | CH₃ | 2 |
| F-35 | H | 3 |
| F-36 | CH₃ | 3 |
| F-37 | H | 4 |
| F-38 | CH₃ | 4 |
| F-39 | H | 6 |
| F-40 | CH₃ | 6 |
| F-41 | H | 8 |
| F-42 | CH₃ | 8 |
| F-43 | H | 10 |
| F-44 | CH₃ | 10 |

Chemical formula 8:

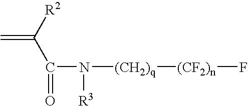

| | R² | R³ | q | n |
|---|---|---|---|---|
| F-45 | H | H | 1 | 3 |
| F-46 | CH₃ | H | 1 | 3 |
| F-47 | H | H | 1 | 6 |
| F-48 | CH₃ | H | 2 | 6 |
| F-49 | H | H | 1 | 8 |
| F-50 | CH₃ | H | 1 | 8 |

Chemical formula 9:

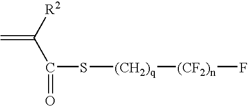

| | R² | q | n |
|---|---|---|---|
| F-51 | H | 2 | 4 |
| F-52 | CH₃ | 2 | 4 |
| F-53 | H | 2 | 6 |
| F-54 | CH₃ | 2 | 6 |
| F-55 | H | 2 | 8 |
| F-56 | CH₃ | 2 | 8 |

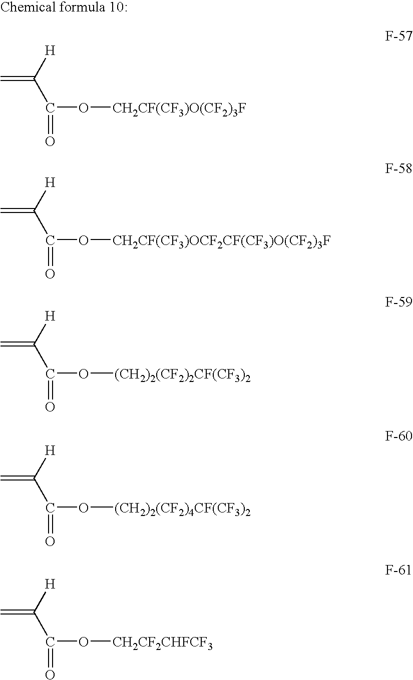

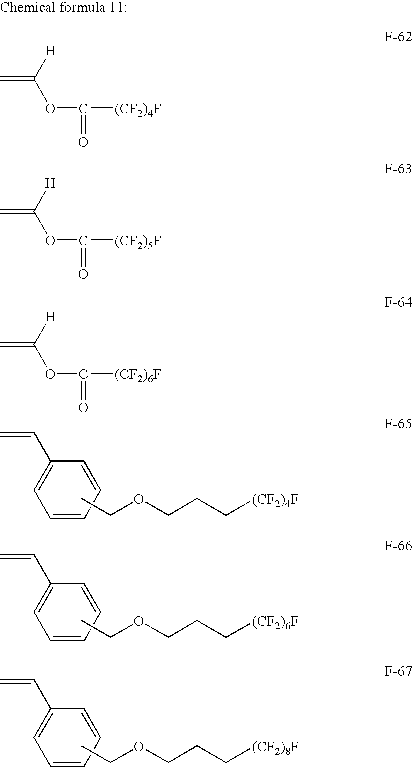

As a substituent that the monomer represented by the general formula (1) can have, there are, for example, a hydroxyl group, a halogen atom, a cyano group, a nitro group, a carboxyl group, a sulfo group, a chain or cyclic alkyl group having a number of carbon atoms of between 1 and 8, an alkenyl group having a number of carbon atoms of between 1 and 8, an alkynyl group having a number of carbon atoms of between 2 and 8, an aralkyl group having a number of carbon atoms of between 7 and 12, an aryl group having a number of carbon atoms of between 6 and 10, an acyl group having a number of carbon atoms of between 1 and 10, an alkoxycarbonyl group having a number of carbon atoms of between 2 and 10, an aryloxycarbonyl group having a number of carbon atoms of between 7 and 12, a carbamoyl group having a number of carbon atoms of between 1 and 10, an alkoxy group having a number of carbon atoms of between 1 to 8, an aryloxy group having a number of carbon atoms of between 6 and 12, an acyloxy group having a number of carbon atoms of between 2 and 12, a sulfonyloxy group having a number of carbon atoms of between 1 and 12, an amino group having a number of carbon atoms of between 0 and 10, an acylamino group having a number of carbon atoms of between 1 and 10, a sulfonylamino group having a number of carbon atoms of between 1 and 8, an ureido group having a number of carbon atoms of between 1 and 10, an urethane group having a number of carbon atoms of between 2 and 10, an alkylthio group having a number of carbon atoms of between 1 and 12, an arylthio group having a number of carbon atoms of between 6 and 12, an alkylsulfonyl group having a number of carbon atoms of between 1 and 8, an arylsulfonyl group having a number of carbon atoms of between 7 and 12, a sulfamoyl group having a number of carbon atoms of between 0 and 8, and a heterocyclic group.

The fluorine atom-containing polymer used in the present invention may be a copolymer that includes one or more types of copolymerizable monomers in addition to the fluoroaliphatic group-containing monomer represented by the aforementioned general formula (1). As such copolymerizable monomer, substances described at chapter 2, pages 1 to 483 of Polymer Handbook second edition, issued by J. Brandrup, Wiley Interscience in 1975 are usable. Such copolymerizable monomer includes, for example, a compound having one addition-polymerizable unsaturated bond chosen from an acrylic acid, a methacrylic acid, acrylic esters, methacrylic esters, acrylamides, methacrylamides, allylic compounds, vinyl ethers, or vinyl esters.

The copolymerizable monomer includes, for example, acrylic esters, methacrylic esters, allylic compounds, vinyl ethers, vinyl esters, dialkyl itaconates, and fumaric dialkyl esters or mono alkyl esters.

The acrylic esters include, for example, methyl acrylate, ethyl acrylate, propyl acrylate, chlorethyl acrylate, 2-hydroxyethyl acrylate, trimethylolpropane mono acrylate, benzyl acrylate, methoxybenzyl acrylate, furfuryl acrylate, tetrahydrofurfuryl acrylate, and poly(oxyalkylene)acrylate.

The methacrylic esters include, for example, ethyl methacrylate, propyl methacrylate, chlorethyl methacrylate, 2-hydroxyethyl methacrylate, trimethylolpropane mono methacrylate, benzyl methacrylate, methoxybenzyl methacrylate, furfuryl methacrylate, tetrahydrofurfuryl methacrylate, and poly(oxyalkylene) methacrylate.

The allylic compounds include, for example, allyl esters and allyloxyethanol.

The allyl esters include, for example, allyl acetate, allyl caproate, allyl caprylate, allyl laurate, allyl palmitate, allyl stearate, allyl benzoate, allyl acetoacetate, and allyl lactate.

The vinyl ethers include, for example, alkyl vinyl ethers. The alkyl vinyl ethers include, for example, hexyl vinyl ether, octyl vinyl ether, decyl vinyl ether, ethylhexyl vinyl ether, methoxyethyl vinyl ether, ethoxyethyl vinyl ether, chlorethyl vinyl ether, 1-methyl-2,2-dimethylpropyl vinyl ether, 2-ethylbutyl vinyl ether, hydroxyethyl vinyl ether, diethylene glycol vinyl ether, dimethylaminoethyl vinyl ether, diethylaminoethyl vinyl ether, butylaminoethyl vinyl ether, benzyl vinyl ether, and tetrahydrofurfuryl vinyl ether.

The vinyl esters include, for example, vinyl butyrate, vinyl isobutyrate, vinyl trimethyl acetate, vinyl diethyl acetate, vinyl valate, vinyl caproate, vinyl chloracetate, vinyl dichloracetate, vinyl methoxyacetate, vinyl butoxyacetate, vinyl lactate, vinyl-β-phenylbutyrate, and vinyl cyclohexyl carboxylate.

The dialkyl itaconates include, for example, dimethyl itaconate, diethyl itaconate, and butyl itaconate.

The fumaric dialkyl esters or mono alkyl esters include, for example, dibutyl fumarate.

In addition, the copolymerizable monomers include, for example, acrylonitrile, methacrylonitrile, maleilonitrile, and styrene.

The fluorine atom-containing polymer used in the present invention may contain two or more types of fluoroaliphatic group-containing monomers, or two or more types of monomers represented by the general formula (1). The fluorine atom-containing polymer may contain one or more types of monomers copolymerizable with the monomer represented by the general formula (1) as a copolymeric component.

In the fluorine atom-containing polymer used in the present invention, a fluoroaliphatic group-containing monomer unit content preferably occupies 25 to 99 weight % in the total polymerized units composing the fluorine atom-containing polymer. When X of the aforementioned general formula (1) is a fluorine atom, the content is more preferably 25 to 60 weight %, further more preferably 30 to 50 weight %, and specifically preferably 35 to 45 weight %. When X is a hydrogen atom, the content is more preferably 50 to 99 weight %, further more preferably 60 to 97 weight %, and specifically preferably 70 to 95 weight %.

The mass-average molecular weight of the fluorine atom-containing polymer used in the present invention is preferably 2,000 to 100,000, more preferably 3,000 to 80,000, and specifically preferably 4,000 to 60,000. The mass-average molecular weight and the molecular weight are measured by a differential refractometer by GPC with use of a column of TSKgel GMHxL, TSKgel G4000HxL, or TSKgel G2000HxL (all above are trade names, made by TOSOH Corporation), and expressed by polystyrene conversion with a THF solvent.

The fluorine atom-containing polymer is manufactured by a commonly known method. To manufacture the fluorine atom-containing polymer, for example, a commercial radical polymerization initiator is added to the aforementioned fluoroaliphatic group-containing monomer, an amide group-containing monomer, or the like in an organic solvent for polymerization. Another addition polymerizable unsaturated compound is added if necessary, and a similar way to above is carried out to manufacture the fluorine atom-containing polymer. A dropping polymerization method, by which the monomer and the initiator are dropped and polymerized in a reaction container in accordance with polymerizability of each monomer, is effective at obtaining a polymer having uniform composition. Depending on the type of used monomer, a method of anionic polymerization, cationic polymerization, emulsion polymerization or the like may be used.

Here are examples of concrete structure of the aforementioned fluorine atom-containing polymer, but the present invention is not limited to the following examples. In chemical formulas, a numeral represents a mass ratio of each monomer component. Mw represents a mass-average molecular weight. In a chemical formula 12, P-1 to P-16 indicate combinations among x, R¹, n, R², R³ and Mw. In a chemical formula 14, P-22 to P-27 indicate combinations among R, n and Mw. In a chemical formula 15, P-28 to P-30 indicate combinations among x, R¹, p, q, R², r, s and Mw. In a chemical formula 16, P-31 to P-35 indicate combinations among a, R¹, p, m, R², q, n and Mw. In a chemical formula 17, P-36 to P-49 indicate combinations among x, R¹, n, R², R³ and Mw.

Chemical formula 12:

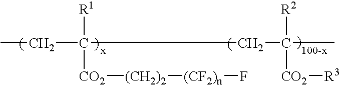

| | x | R¹ | n | R² | R³ | Mw |
|---|---|---|---|---|---|---|
| P-1 | 40 | H | 4 | CH₃ | CH₃ | 11,000 |
| P-2 | 30 | H | 4 | H | C₄H₉(n) | 7,000 |
| P-3 | 35 | H | 4 | H | —(CH₂CH₂O)₂—CH₃ | 16,000 |
| P-4 | 40 | H | 6 | H | —(C₃H₆O)₂—H | 23,000 |
| P-5 | 40 | H | 6 | H | CH₃ | 35,000 |
| P-6 | 40 | H | 6 | H | —OCH₂CH₂OC₂H₅ | 15,000 |
| P-7 | 40 | H | 6 | H | —(CH₂CH₂O)₈—H | 16,000 |
| P-8 | 45 | CH₃ | 6 | CH₃ | —(C₃H₆O)₂₀—H | 24,000 |
| P-9 | 25 | CH₃ | 6 | CH₃ | CH₃ | 23,000 |
| P-10 | 30 | H | 6 | H | —C₄H₉(t) | 18,000 |
| P-11 | 40 | H | 8 | H | C₂H₅ | 24,000 |
| P-12 | 30 | CH₃ | 8 | CH₃ | C₄H₉(n) | 9,000 |
| P-13 | 20 | H | 8 | H | —(CH₂CH₂O)₉—CH₃ | 20,000 |
| P-14 | 30 | H | 8 | CH₃ | —(CH₂CH₂O)₂—H | 20,000 |
| P-15 | 30 | H | 10 | CH₃ | H | 17,000 |
| P-16 | 25 | H | 10 | H | H | 9,000 |

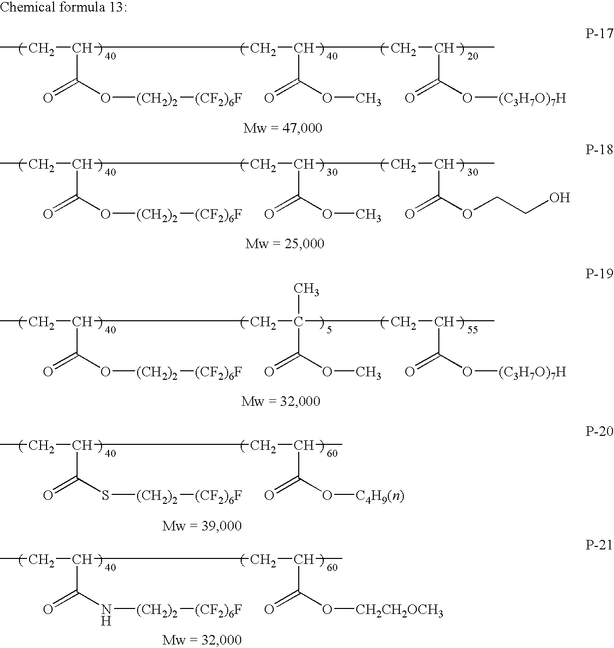

Chemical formula 14:

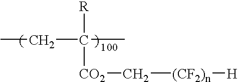

| | R | n | Mw |
|---|---|---|---|
| P-22 | H | 4 | 24,000 |
| P-23 | CH₃ | 4 | 12,000 |
| P-24 | H | 6 | 14,000 |
| P-25 | CH₃ | 6 | 21,000 |
| P-26 | H | 8 | 16,000 |
| P-27 | CH₃ | 8 | 10,000 |

Chemical formula 15:

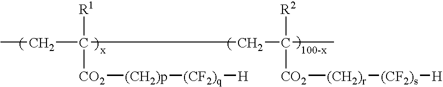

| | x | R¹ | p | q | R² | r | s | Mw |
|---|---|---|---|---|---|---|---|---|
| P-28 | 40 | H | 1 | 4 | H | 1 | 6 | 14,000 |
| P-29 | 40 | H | 1 | 4 | H | 1 | 8 | 16,000 |
| P-30 | 50 | H | 1 | 6 | H | 1 | 8 | 16,000 |

Chemical formula 16:

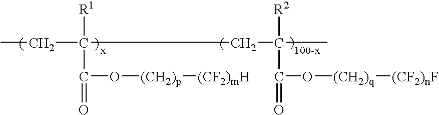

| | a | R¹ | p | m | R² | q | n | Mw |
|---|---|---|---|---|---|---|---|---|
| P-31 | 80 | CH₃ | 1 | 4 | CH₃ | 2 | 4 | 21,000 |
| P-32 | 90 | H | 1 | 4 | H | 2 | 6 | 19,000 |
| P-33 | 95 | H | 1 | 4 | H | 2 | 8 | 7,000 |
| P-34 | 90 | H | 1 | 6 | H | 2 | 4 | 13,000 |
| P-35 | 90 | H | 1 | 6 | H | 2 | 6 | 16,000 |

Chemical formula 17:

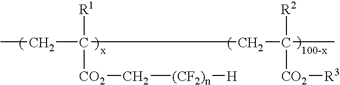

| | x | R¹ | n | R² | R³ | Mw |
|---|---|---|---|---|---|---|
| P-36 | 80 | H | 4 | CH₃ | CH₃ | 11,000 |
| P-37 | 90 | H | 4 | H | C₄H₉(n) | 7,000 |
| P-38 | 80 | H | 4 | H | —(CH₂CH₂O)₂—CH₃ | 16,000 |
| P-39 | 80 | H | 4 | H | —(C₃H₆O)₇—H | 24,000 |
| P-40 | 95 | H | 6 | H | H | 11,000 |
| P-41 | 80 | CH₃ | 6 | CH₃ | CH₃ | 15,000 |
| P-42 | 90 | H | 6 | H | —(CH₂CH₂O)₈—H | 16,000 |
| P-43 | 85 | CH₃ | 6 | CH₃ | —(C₃H₆O)₂₀—H | 24,000 |
| P-44 | 70 | H | 8 | H | C₂H₅ | 24,000 |
| P-45 | 80 | H | 8 | CH₃ | C₄H₉(t) | 9,000 |
| P-46 | 95 | H | 8 | H | —(CH₂CH₂O)₉—CH₃ | 20,000 |
| P-47 | 80 | H | 8 | CH₃ | —(CH₂CH₂O)₂—H | 20,000 |
| P-48 | 70 | H | 10 | CH₃ | H | 17,000 |
| P-49 | 90 | H | 10 | H | H | 9,000 |

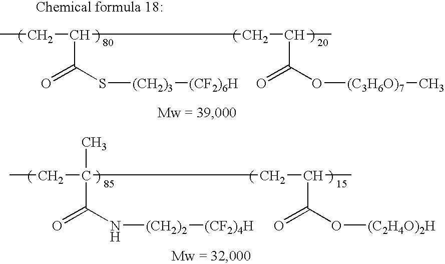

In the present invention, a single type of fluorine atom-containing polymer may be used alone, or two or more types of fluorine atom-containing polymers may be used in combination.

It is preferable that the additive amount of the surface-active agent be 0.01 mass % to 10 mass % of the total amount. In other words, when x1 represents the mass of the surface-active agent and y1 represents the mass of the film, the surface-active agent is preferably added to the application liquid so that a value of 100×x1/y1 is between or equal to 0.01 (mass %) and 10 (mass %). The surface-active agent is not necessarily added to the application liquid. For example, the surface-active agent may be mixed with another material of the application liquid to make the application liquid. The additive amount of the surface-active agent is more preferably 0.05 mass % to 5 mass %, further more preferably 0.1 mass % to 3 mass %, and most preferably 0.1 mass % or more and less than 1 mass %.

(Application Liquid)

The application liquid contains an organic solvent and a polymer, and furthermore contains a polyfunctional monomer, a photopolymerization initiator, or another component if necessary.

(1) Organic Solvent

As the organic solvent, any solvent is available as long as the solvent dissolves the polymer. There are, for example, chloroform, dichloromethane, carbon tetrachloride, cyclohexane, and methyl acetate.

The application liquid contains such a concentration of polymer in being casted as to be formable of a cast film, and the polymer concentration is preferably between or equal to 0.01 mass % and 30 mass %, for example. If the polymer concentration is less than 0.01 mass %, productivity of the film is reduced, and is unsuitable for industrial mass production. If the polymer concentration exceeds 30 mass %, the film has been dried before adequate growth of water drops in a condensation and drying step described later, and causes difficulty in making microporous structure with a preferable pore size.

(2) Polymer

The polymer is not specifically limited, and is appropriately chosen in accordance with intended use. For example, at least one type of hydrophobic polymer or amphiphilic polymer is suitable.

Hydrophobic Polymer

The hydrophobic polymer is not specifically limited, and is appropriately chosen among publicly known ones in accordance with the intended use. The hydrophobic polymer includes, for example, vinyl polymer (for example, polyethylene, polypropylene, polystyrene, polyacrylate, polymethacrylate, polyacrylamide, polymethacrylamide, polyvinyl chloride, polyvinylidene chloride, polyvinylidene fluoride, polyhexafluoropropene, polyvinyl ether, polyvinylcarbazole, polyvinyl acetate, and polytetrafluoroethylene), polyester (for example, polyethylene terephthalate, polyethylene naphthalate, polyethylene succinate, polybutylene succinate, and polylactic acid), polylactone (for example, polycaprolactone), polyamide or polyimide (for example, nylon and polyamide acid), polyurethane, polyurea, polybutadiene, polycarbonate, polyaromatics, polysulfone, polyether sulfone, a polysiloxane derivative, and cellulose acylate (triacetyl cellulose, cellulose acetate propionate, and cellulose acetate butyrate). These polymers may be in the form of a homopolymer, a copolymer, or a polymer blend in terms of solubility, optical properties, electric properties, film strength, elasticity, and the like. These polymers may be used in the form of a mixture of two or more types of polymers if necessary. In optical application, for example, the cellulose acylate or cyclic polyolefin is preferable.

The amphiphilic polymer is not specifically limited, and is appropriately chosen in accordance with the intended use. The amphiphilic polymer includes, for example, an amphiphilic polymer having a polyacrylamide main chain and both of a dodecyl group as a hydrophobic side chain and a carboxyl group as a hydrophilic side chain, and polyethylene glycol/polypropylene glycol block copolymers.

It is preferable that the hydrophobic side chain be a nonpolar linear group such as an alkylene group or a phenylene group, and do not have a branched hydrophilic group such as a polar group or an ionic dissociable group until a distal end, except for a linking group such as an ester group or an amide group. Taking the use of the alkylene group as an example, the hydrophobic side chain is preferably composed of five or more methylene units.

It is preferable that the hydrophilic side chain have a hydrophilic portion such as a polar group, an ionic dissociable group, or an oxyethylene group at a distal end via a linking portion such as an alkylene group.

The ratio between the hydrophobic side chain and the hydrophilic side chain cannot be generally defined because the ratio depends on size, the degree of nonpolarity and polarity, the degree of hydrophobicity of the hydrophobic organic solvent and the like. The hydrophobic side chain and the hydrophilic side chain, however, preferably have a unit ratio (hydrophobic side chain/hydrophilic side chain) of 3/1 to 1/3. In the case of a copolymer, a block copolymer is preferable in which the hydrophobic side chain and the hydrophilic side chain form a block without affecting solubility to a hydrophobic solvent, rather than an alternating copolymer of the hydrophobic side chain and the hydrophilic side chain.

The mean molecular weight (Mn) of the hydrophobic polymer and the amphiphilic polymer is preferably 1,000 to 10,000,000, and more preferably 5,000 to 1,000,000.

Only the hydrophobic polymer can form the honeycomb structure film, but is preferably used together with the amphiphilic polymer.

The composition ratio (mass ratio) between the hydrophobic polymer and the amphiphilic polymer is preferably 99:1 to 50:50, and more preferably 98:2 to 70:30. The ratio of the amphiphilic polymer is less than 1 mass %, uniform honeycomb structure may not be obtained. The ratio of the amphiphilic polymer exceeds 50 mass %, on the other hand, the sufficient stability of the film, especially the sufficient dynamical stability may not be obtained.

It is also preferable that the hydrophobic polymer and the amphiphilic polymer be a polymeric (cross-linked) polymer that has a polymeric group in a molecule. It is also preferable that a polymerizable polyfunctional monomer be formulated into the hydrophobic polymer and/or the amphiphilic polymer. After a honeycomb film is formed out of this formulation, the honeycomb film is preferably subjected to hardening processing by a known method such as heat hardening, ultraviolet curing or electron radiation curing.

As the polyfunctional monomer used with the hydrophobic polymer and/or the amphiphilic polymer, polyfunctional (meth)acrylate is preferable due to its reactivity. Examples of the polyfunctional (meth)acrylate include dipentaerythritol dipentaerythritol hexaacrylate, dipentaerythritol caprolactone adduct hexaacrylate or denaturations thereof, epoxy acrylate oligomer, polyester acrylate oligomer, urethane acrylate oligomer, N-vinyl-2-pyrrolidone, tripropylene glycol diacrylate, polyethylene glycol diacrylate, trimethylolpropane triacrylate, pentaerythritol triacrylate, pentaerythritol tetraacrylate, and denaturations of above. These polyfunctional monomers are used alone or in combination with two or more types thereof for striking a balance between abrasion resistance and flexibility.

If the hydrophobic polymer and the amphiphilic polymer are polymeric (cross-linked) polymers having the polymeric groups in molecules, it is also preferable to use a polyfunctional monomer reactable with the polymeric groups of the hydrophobic polymer and the amphiphilic polymer.

A monomer having an ethylene unsaturated group is polymerized by irradiation with ionizing radiation or heating under the presence of a photo-radical initiator or a thermal radical initiator. Thus, an application liquid may be formulated from the monomer having the ethylene unsaturated group, the photo-radical initiator or the thermal radical initiator, mat particles, and an inorganic filler. After the application liquid is applied to a transparent support material, the application liquid is hardened by polymerization reaction with the ionizing radiation or heating to produce an antireflection film.

The photo-radical initiator includes, for example, acetophenones, benzoins, benzophenones, phosphine oxides, ketals, anthraquinones, thioxanthones, an azo compound, peroxides, 2,3-alkyldione compounds, disulfide compounds, fluoroamine compounds, and aromatic sulfoniums.

The acetophenones include, for example, 2,2-ethoxyacetophenone, p-methylacetophenone, 1-hydroxydimethyl phenyl ketone, 1-hydroxycyclohexyl phenyl ketone, 2-methyl-4-methylthio-2-morpholino propiophenone, and 2-benzyl-2-dimethylamino-1-(4-morpholinophenyl)-butanone.

The benzoins include, for example, benzoin benzene sulphonate ester, benzoin toluene sulphonate ester, benzoin methyl ether, benzoin ethyl ether, and benzoin isopropyl ether.

The benzophenones include, for example, benzophenone, 2,4-chlorobenzophenone, 4,4-dichlorobenzophenone, and p-chlorobenzophenone.

The phosphine oxides include, for example, 2,4,6-trimethylbenzoyl diphenylphosphine oxide.

Various examples of the photo-radical initiator are described in the Latest UV Hardening Technology (page 159, issued by Kazuhiro Takasuki, from Technical Information Institute Co., Ltd., in 1991). A commercially available photo-cleavage type photo-radical polymerization initiator preferably includes IRGACURE® (651, 184, 907) made by Chiba Specialty Chemicals.

The photo-radical initiator is preferably used in a range of 0.1 to 15 parts by weight with respect to the polyfunctional monomer of 100 parts by weight, and is more preferably in a range of 1 to 10 parts by weight.

In addition to the photo-radical polymerization initiator, a photosensitizer may be used. Concrete examples of the photosensitizer include n-butylamine, triethylamine, tri-n-butylphosphine, Michler's ketone, and thioxanthone.

As the thermal radical initiator, for example, organic peroxide, inorganic peroxide, an organic azo compound, or an organic diazo-compound is available.

To be more specific, the organic peroxide includes, for example, benzoyl peroxide, halogen benzoyl peroxide, lauroyl peroxide, acetyl peroxide, dibutyl peroxide, cumene hydroperoxide, and butyl hydroperoxide. The inorganic peroxide includes hydrogen peroxide, ammonium persulfate, potassium persulfate, and the like. The azo compound includes, for example, 2,2′-azobis(isobutyronitrile), 2,2′-azobis(propionitrile), and 1,1′-azobis(cyclohexanecarbonitrile). The diazo-compound includes, for example, diazoaminobenzene and p-nitrobenzenediazonium.

Honeycomb porous structure formed by the self-organization means structure in which pores of a uniform shape and a uniform size are continuously and orderly arranged. This orderly arrangement is in two dimensions in the case of a single layer, and is in three dimensions in the case of plural layers. In the two dimensions, a plurality of pores (for example, six pores) are arranged so as to surround a single pore. In the three dimensions, the pores are often closely packed into a crystal structure such as a face-centered cubic structure or a hexagonal system, but the pores may show regularity except above depending on a production condition.

In the microporous structure, the diameter of the pore is preferably 30 μm or less, and more preferably between or equal to 0.01 μm and 10 μm. If the diameter of the pore exceeds 30 μm, strength is reduced, and the film tends to tear during stretch.

To reduce the pore diameter of the microporous structure, acceleration of a drying rate is effective. More specifically, there are effective ways in which a solvent with a low boiling point is used, temperature of the support material is increased, an application liquid expansion speed is accelerated and the thickness of an initial expansion liquid is reduced, and the like.

The thickness of the film is approximately from the pore diameter to 200 μm. It is also possible to provide a thick layer without pores on the side of the support material, by increasing the expanded polymer concentration. In this case, the thickness of the thick layer without the pores is controllable from 1 to 500 μm.

(Support Material)

It is preferable that the film of the present invention have the support material. The support material is not specifically limited as long as the support material is translucent and has a certain degree of strength, and is appropriately chosen in accordance with the intended use. The support material includes, for example, an inorganic material such as glass, metal, and silicon wafer; polyester including polyethylene terephthalate and polyethylene naphthalate; polyolefin including polyethylene and polypropylene; an organic material insoluble in an organic solvent such as polyamide, polyether, polystyrene, polyesteramide, polycarbonate, polyphenylene sulfide, polyether ester, polyvinyl chloride, poly acrylic ester, poly methacrylic ester, polyether ketone, and polyethylene fluoride; a liquid such as water, liquid paraffin, and liquid polyether.

The thickness of the support material is not specifically limited as long as the thickness is in a generally adopted range, and is appropriately determined in accordance with the intended use. The thickness, however, is preferably 0.02 to 4.0 m, for example.

(Manufacturing Method of the Film)

A method for manufacturing the film according to the present invention includes a film production process, and further includes another process if necessary.

(1) Film Production Process

In the film production process, the surface-active agent, which reduces the surface tension of the application liquid, is added to the application liquid containing the organic solvent and the polymer (hereinafter also called “macromolecular compound”), and the application liquid with the surface-active agent is applied (casted) onto the support material to form the film. Then, liquid drops are formed inside the film, and the organic solvent and the liquid drops are evaporated to produce the film having hollow pores inside.

A casting method is not specifically limited, and is appropriately chosen in accordance with the intended use. There are, for example, a sliding method, an extrusion method, a bar coating method, and a gravure coating method.

In an environment for carrying out film production, relative humidity is preferably from 50 to 95%. If the relative humidity is less than 50%, condensation of moisture can be insufficient on a solvent surface. If the relative humidity exceeds 95%, the environment is hard to control, and the uniform film production cannot be maintained.

In the environment for carrying out the film production, stationary air having a constant air volume in addition to a constant relative humidity is preferably blown. A relative air speed to the film is preferably from 0.02 to 2 m/s. If the relative air speed is less than 0.02 m/s, the environment can be hard to control. A relative air speed of more than 2 m/s can cause disorder in the solvent surface and difficulty in the uniform film production.

The stationary air can be blown in any direction as long as the angle that the stationary air forms with a surface of the support material is from 0 to 90°, but preferably from 0 to 60° to increase uniformity in the honeycomb structure.

As gas that is blown at a regulated humidity and a regulated flow rate during the film production, an inert gas such as a nitrogen gas or an argon gas is available instead of air. The gas is preferably subjected to a dust removing process by being passed through a filter in advance. Since dust in the environment becomes a condensation nucleus of water vapor and affects the film production, a dust removing system or the like is preferably set up in a manufacturing site too.

It is preferable that the environment for carrying out the film production be strictly controlled by using a commercial constant dew point humidity generator or the like. The air volume is preferably controlled at constant, and closed space is preferably used to prevent influence of outside air. It is preferable that a gas inlet and outlet path and the film production environment be set up so that the gas is replaced in a room by a laminar flow. To control the quality of the produced film, it is preferable to monitor temperature, the humidity, the air volume and the like by measuring instruments. To regulate the pore diameter and the film thickness with high precision, these parameters (especially, the humidity and the air volume) have to be strictly controlled.

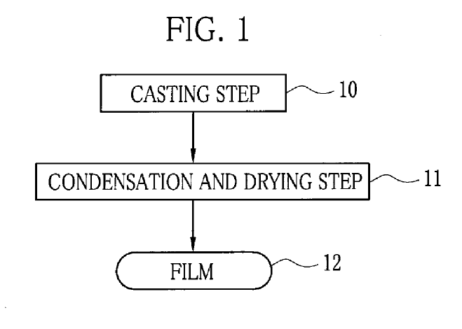

FIG. 1 shows a manufacturing process chart of the film according to the present invention. A macromolecular solution is casted onto the support material at a casting step 10 to form a film (hereinafter also called “macromolecular film”). After that, water vapor is condensed into liquid drops on a surface of the macromolecular film, and the liquid drops get into the macromolecular film at a condensation and drying step 11. The condensation and drying step 11 will be described in detail later on. The solvent and the liquid drops of the macromolecular solution are evaporated to obtain a film 12 with micropores. A light irradiation step for irradiating the macromolecular film with light may be carried out while the film 12 is made out of the macromolecular film, in other words, at least one of a period between the casting step 10 and the condensation and drying step 11 and a period during the condensation and drying step 11. In this case, ultraviolet rays, an electron beam or the like is used as irradiation light.

The macromolecular compound soluble in a water-insoluble solvent (hereinafter also called “hydrophobic polymer compound”) as described above is preferable usable as a material of the film 12. The film 12 is made out of only the hydrophobic polymer, but an amphiphilic material is preferably used together with the hydrophobic polymer. The used amphiphilic material is appropriately chosen from above.

A solvent (organic solvent) for dissolving the macromolecular compound therein and preparing the macromolecular solution is appropriately chosen from above.

The surface tension of the application liquid that contains the organic solvent and the macromolecular compound with the surface-active agent is preferably 25 mN/m or less, more preferably from 10 to 23 mN/m, and most preferably from 12 to 21 mN/m.

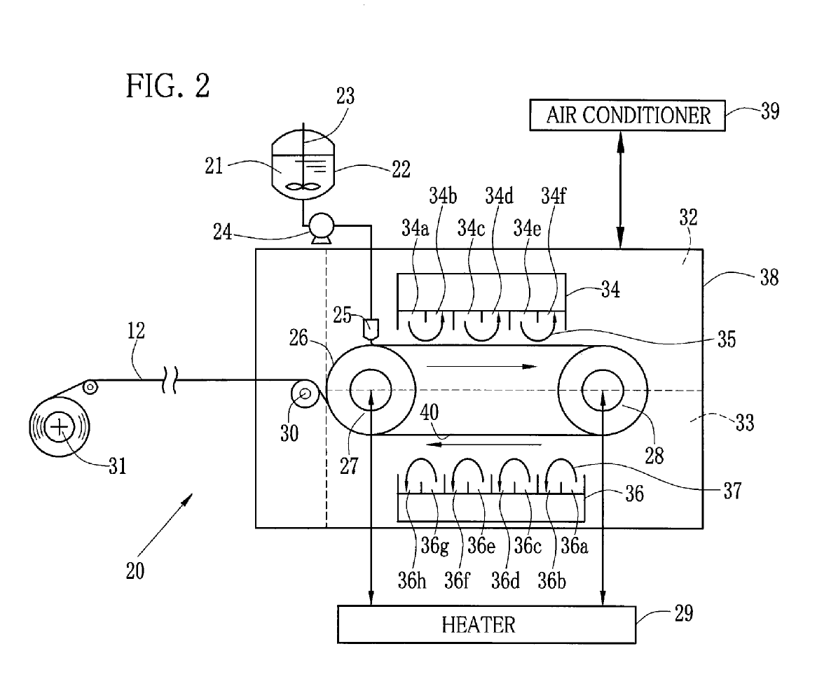

Next, FIG. 2 shows a schematic view of a film manufacturing apparatus 20 for manufacturing the film 12 (hereinafter also called “honeycomb structure film”) according to the present invention. The macromolecular solution 21 is contained in a tank 22. The tank 22 is provided with an agitator 23, and rotation of the agitator 23 uniformly mixes the macromolecular solution 21. The macromolecular solution 21 is conveyed into a casting die 25 by a pump 24. The casting die 25 is disposed above a casting belt 26. The casting belt 26 is looped over rotatable rollers 27 and 28. Since the rotatable rollers 27 and 28 are rotated by a not-illustrated driving unit, the casting belt 26 endlessly travels. To the rotatable rollers 27 and 28, a heater 29 is attached. By regulating the temperatures of the rotatable rollers 27 and 28, the temperature of the casting belt 26 is controllable. The film manufacturing apparatus 20 is also provided with a peel roller 30 for supporting a macromolecular film 40 in peeling the macromolecular film 40 from the casting belt 26, and a winder 31 for winding the macromolecular film 40 as a film.

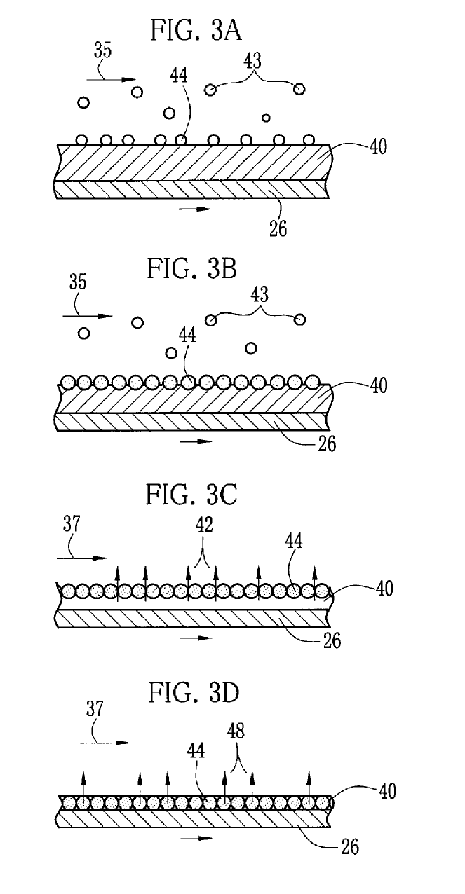

At the casting step 10, the macromolecular solution 21 is casted from the casting die 25 onto the casting belt 26 to form the macromolecular film 40. Subsequently, the condensation and drying step 11 (refer to FIG. 1) is carried out. The condensation and drying step 11 will be described with referring to FIGS. 3A to 3D. As shown in FIG. 3A, the macromolecular film 40 is formed on the casting belt 26. TL (° C.) represents the surface temperature (hereinafter also called “film surface temperature”) of the macromolecular film 40. In the present invention, it is preferable that the film surface temperature TL be 0° C. or more. If the film surface temperature TL is less than 0° C., the liquid drops inside the macromolecular film 40 can freeze and desired pores may not be formed.

A casting chamber for carrying out casting is partitioned into a condensation zone 32 and a drying zone 33, as shown in FIG. 2. The condensation zone 32 is provided with an air blower 34. The air blower 34 blows air 35, which is regulated for condensation, on the macromolecular film 40 on the casting belt 26. The air blower 34 is preferably composed of a plurality of air blow units that have air discharge ports 34a, 34c and 34e and air intake ports 34b, 34d and 34f, as shown in FIG. 2. Thus, a condensation condition of the macromolecular film 40 is easily regulated. The air blower 34 is composed of three air blow units in FIG. 2, but the present invention is not limited to that.

The drying zone 33 is provided with a dryer 36. The dryer 36 blows dry air 37 on the macromolecular film 40. The dryer 36 is preferably composed of a plurality of air blow units that have air discharge ports 36a, 36c, 36e and 36g and air intake ports 36b, 36d, 36f and 36h, as shown in FIG. 2. Thus, a drying condition of the macromolecular film 40 is easily regulated. The dryer 36 is composed of four air blow units in FIG. 2, but the present invention is not limited to that.

It is more preferable to regulate the temperature of the casting belt 26 through the rotatable rollers 27 and 28 by using the heater 29. There is a method for regulating the temperature in which liquid conveyor ducts are provided inside the rotatable rollers 27 and 28, and a heat transfer medium is conveyed through the liquid conveyor ducts, or the like. By the temperature regulation, the temperature of the casting belt 26 is preferably set at 0° C. at a lower limit value or more. An upper limit value of the temperature is preferably a boiling point of the solvent of the macromolecular solution 21 or less, and more preferably “the boiling point of the solvent minus 3° C.”. Thus, condensed water does not freeze, and abrupt evaporation of the solvent of the macromolecular solution 21 is prevented, and hence the honeycomb structure film 12 with favorable shape is obtained. Furthermore, regulating the temperature distribution of the macromolecular film 40 within ±3° C. in a width direction allows the temperature distribution of the film surface to be regulated within ±3° C. Reduction in the temperature distribution of the macromolecular film 40 in the width direction prevents occurrence of pore form anisotropy in the honeycomb structure film 12, and results in increasing a commodity value.

A conveyance direction of the casting belt 26 is preferably set within ±10° with respect to the horizontal. In a like manner, the width direction of the macromolecular film 40, which forms 90° with the conveyance direction, is preferably set within ±10° with respect to the horizontal. Regulating angles of the conveyance direction and the width direction facilitates regulating form of liquid drops 44. Regulating the form of the liquid drops 44 allows regulation of form of pores.

The air blower 34 blows the air 35. The dew point TD1 (° C.) of the air 35 preferably satisfies 0° C.≦(TD1−TL)° C., when TL (° C.) represents the surface temperature of the macromolecular film 40 passing through the condensation zone 32. The dew point TD1 (° C.) more preferably satisfies 0° C.≦(TD1−TL)° C.≦80° C., and is furthermore preferably between or equal to 5° C. and 60° C., and is especially preferably between or equal to 10° C. and 40° C. If the (TD1−TL)° C. is less than 0° C., condensation is often hard to generate. If the (TD1−TL)° C. exceeds 80° C., condensation and drying are carried out too fast to make it difficult to control the pore size and uniformity thereof. The temperature of the air 35 is not specifically limited and is appropriately determined in accordance with the intended use, but is preferably between or equal to 5° C. and 100° C. If the temperature of the air is less than 5° C., liquid, especially water is hard to evaporate, and thus the honeycomb structure film 12 having favorable shape cannot be obtained. If the temperature of the air exceeds 100° C., the liquid drops 44 can be volatilized as water vapor before occurring in the macromolecular film 40.

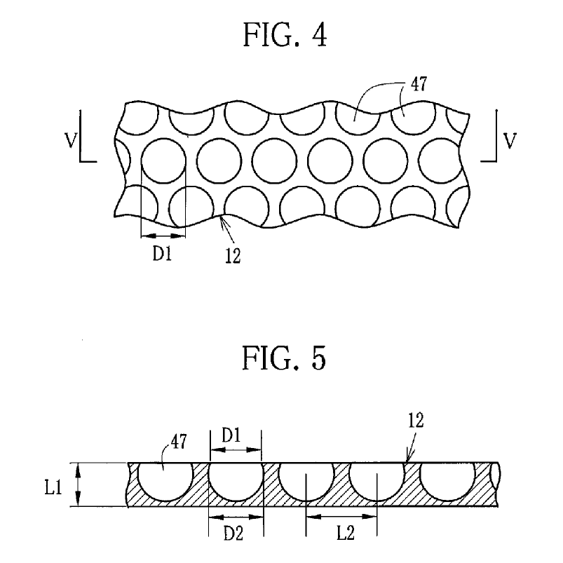

In the condensation zone 32, as shown in FIG. 3A, moisture (modeled in illustration) 43 contained in the air 35 condenses on the macromolecular film 40 into the liquid drops 44. Then, as shown in FIG. 3B, the moisture 43 condenses on condensation nuclei of the water drops 44, and the water drops 44 grow. In the drying zone 33, as shown in FIG. 3C, upon blowing the drying air 37 on the macromolecular film 40, an organic solvent 42 evaporates from the macromolecular film 40. At this time, water evaporates from the liquid drops 44 too, but an evaporation rate of the organic solvent 42 is higher than that of the water. Accordingly, the liquid drops 44 come to have an almost uniform shape due to surface tension, with evaporation of the organic solvent 42. When drying is further continued, as shown in FIG. 3D, the liquid drops 44 in the macromolecular film 40 evaporate as water vapor 48. Upon evaporation of the liquid drops 44 from the macromolecular film 40, positions where the liquid drops 44 have been existed become pores 47, and hence the honeycomb structure film 12 as shown in FIGS. 4 and 5 is obtained.

The form of the honeycomb structure film 12 is not specifically limited in the present invention, but in a concretive manner, the distance L2 between the pores 47 adjoining to each other can be regulated between or equal to 0.05 μm and 100 μm by a center-to-center distance. Since more than half of the liquid drop 44 gets into the macromolecular film 40 during manufacture, the opening diameter D1 of the pore in the surface of the honeycomb structure film 12 is smaller than the diameter D2 of the pore. By narrowing the distance between the liquid drops 44, the pores can be coupled with a communication path formed therein. As described above, the present invention is not limited to an embodiment shown in FIGS. 4 and 5. As described above, the honeycomb structure film 12 is formed out of the application liquid that contains the fluorine atom-containing surface-active agent for reducing the surface tension. Thus, since the honeycomb structure film 12 contains the fluorine atom-containing surface-active agent, dirt or dust is less likely to adhere in comparison with a conventional film. Containing the surface-active agent in the application liquid facilitates formation of the pores of a uniform size inside the film.

The air 35 is a following wind, and blows in parallel (parallel flow) with the conveyance direction of the macromolecular film 40. If the air is an opposing wind, the surface of the macromolecular film 40 is disordered, and growth of the liquid drops can be inhibited. The air 35 has such a blow speed that a relative speed to a conveyance speed of the macromolecular film 40 is preferably between or equal to 0.02 m/s and 2 m/s, more preferably between or equal to 0.05 m/s and 1.5 m/s, and further more preferably between or equal to 0.1 m/s and 1 m/s. If the relative speed is less than 0.02 m/s, the macromolecular film 40 can be conveyed to the drying zone 33 before the liquid drops 44 have not sufficiently grown inside the macromolecular film 44. If the relative speed exceeds 2 m/s, the surface of the macromolecular film 40 can be disordered, or the condensation cannot sufficiently proceed.

The time it takes the macromolecular film 40 to pass through the condensation zone 32 is preferably between or equal to 0.1 second and 1000 seconds. If the time is less than 0.1 second, the desired pores are difficult to form because the liquid drops 44 have not sufficiently grown. If the time exceeds 1000 seconds, the liquid drops 44 grow too large to form the honeycomb structure film.

The blow speed of the drying air 37, which dries the macromolecular film 40 in the drying zone 33, is preferably between or equal to 0.02 m/s and 20 m/s, more preferably between or equal to 0.1 m/s and 10 m/s, and further more preferably between or equal to 0.5 m/s and 5 m/s. If the blow speed is less than 0.02 m/s, evaporation of water from the liquid drops 44 cannot sufficiently proceed, and productivity is reduced. If the blow speed exceeds 20 m/s, the water abruptly evaporates from the liquid drops 44, and the form of the pores 37 may be disordered.

When TD2 (° C.) represents the dew point of the drying air 37, the relation between TD2 and the film surface temperature TL (° C.) preferably satisfies (TL-TD2)° C.≧1° C. Thus, the liquid drops 44 on the macromolecular film 40 stop growing in the drying zone 33, and water in the liquid drops is volatilized as the water vapor 48.

The air blowers 34 and 37 may adopt a vacuum drying method to dry the macromolecular film 40, instead of a method of blowing air from so-called two dimensional nozzles, which have the air discharge ports 34a, 34c, 34e, 37a, 37c, 37e and 37g for discharging air and the air intake ports 34b, 34d, 34f, 37b, 37d, 37f and 37h for sucking air. The vacuum drying facilitates easy regulation of evaporation rates of the organic solvent 42 and the moisture 43 contained in the liquid drops 44. The regulation of the evaporation rates makes it possible to vary the size and shape of the pores in the present invention, in which the liquid drops 44 formed in the macromolecular film 40 are evaporated with evaporation of the organic solvent 42 to form the pores 47 in positions where the water drops have existed.

In addition to the vacuum drying method, is adoptable another drying method in which a condenser that is cooler than the film surface and has a groove in its surface is disposed 3 to 20 mm away from the film surface, and the water vapor (containing the volatilized organic solvent) is condensed on the surface of the condenser. Adopting any of the above drying methods can reduce dynamic effect on the surface of the macromolecular film 40 during drying, and hence allows obtainment of further flat film surface.

Providing a plurality of air blow units in the air blower 34 and the dryer 36 and partitioning the room into a plurality of zones make it possible to set various dew point conditions and various drying temperature conditions. Choice of these conditions facilitates improvement in controllability of size of the pores 47 and uniformity of the pores 47. The number of the air blow units and the number of the zones are not specifically limited, but are optimally determined in terms of film quality and facility cost.

The relation between the film surface temperature TL (° C.) and the dew point TD1 (° C.) of the condensation zone preferably satisfies 0° C.≦|TD1−TL|° C.≦80° C., and the relation between the film surface temperature TL (° C.) and the dew point TD2 (° C.) of the drying zone preferably satisfies 0° C.≦|TD2−TL|° C.≦80° C. By restricting the difference between the dew point TD1 (° C.) of the condensation zone and the film surface temperature TL (° C.) or between the dew point TD2 (° C.) of the drying zone and the film surface temperature TL (° C.) to 80° C. or less, abrupt volatilization of at least one of the organic solvent and the water can be prevented, and the honeycomb structure film 12 having desired form is obtained. Also, mixing of an impurity in the macromolecular film 40 inhibits formation of the honeycomb structure. Accordingly, a dust level of the air discharge ports 34a, 34c, 34e, 36a, 36c, 36e and 36g is preferably kept at Class 1000 or better. It is preferable that each unit of the air blower 34 and the dryer 36 be provided with a filter in its air supply system to remove dust or the like, and air conditions inside a housing 38 be controlled with keeping the favorable dust level. Accordingly, the fear of mixing of the impurity in the macromolecular film 40 is reduced, and the favorable honeycomb structure film 12 is obtained. In addition to that, an air conditioner 39 preferably carries out air cleaning and regulates the temperature and the humidity of the condensation zone 32 and the drying zone 33.

The dried honeycomb structure film 12 is peeled from the casting belt 26 with support of the peel roller 30, and is wound around the winder 31. The conveyance speed of the honeycomb structure film 12 is not specifically limited, but is preferably between or equal to 0.1 m/min and 60 m/min. The conveyance speed of less than 0.1 m/min causes low productivity and is detrimental to cost. If the conveyance speed exceeds 60 m/min, on the other hand, excessive tension is applied during conveyance of the honeycomb structure film, and causes occurrence of defectiveness such as a tearing and disorder in the honeycomb structure. The honeycomb structure film 12 is continuously manufactured by the method described above. On the other hand, by intermittent or discontinuous application of the macromolecular solution 21, the shorter honeycomb structure film 12 can be manufactured.

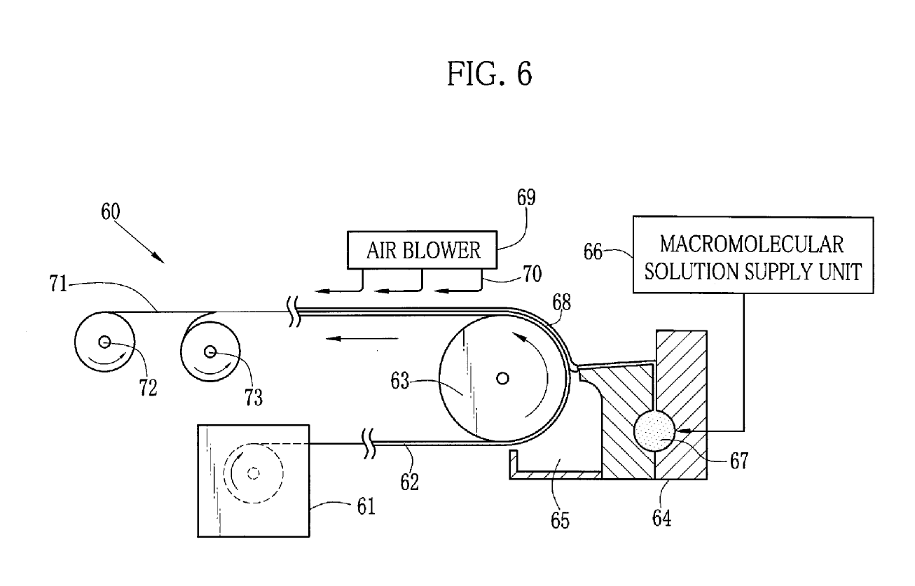

FIG. 6 shows a film manufacturing apparatus 60 according to another embodiment of the present invention. A support film feeder 61 feeds a support film 62 being a support material. The support film 62 is conveyed with being looped over a backup roller 63. In front of the backup roller 63, a slider coater 64 is disposed. The slide coater 64 has a decompression chamber 65. A macromolecular solution 67 being an application liquid that is conveyed from a macromolecular solution supply unit 66 by a pump is extruded from the slide coater 64, and applied onto the support film 62 being the support material to form a macromolecular film 68.

The slide coater 64 is good at uniformly applying the macromolecular solution 67 in a conveyance direction of the support film 62, and at forming the macromolecular film 68 at high speed. Thus, the slide coater 64 is a coater that realizes high productivity. If the surface of the support film 62 being the support material is uneven, the support film 62 is smoothed while being looped over the backup roller 63, so that the macromolecular solution 67 can be uniformly applied thereon. Furthermore, since application is carried out without making contact with the support film 62, the macromolecular solution 67 can be uniformly applied without scratching a surface of the support film 62.

The macromolecular film 68 formed on the support film 62 is subjected to the condensation and drying step 11 in which an air blower 69 blows air 70 on the macromolecular film 68. Description of conditions of the condensation and drying step 11 will be omitted as long as the conditions are the same as above. After completion of the condensation and drying step 11, a honeycomb structure film 71 is wound into a roll 72. The support film 62 is also wound into a roll 73. A conveyance direction of the support film 62 on which the macromolecular film 68 is formed is preferably ±10° or less with respect to the horizontal. It is more preferable that the support film 62 be made of a material that easily absorbs the organic solvent of the macromolecular solution 67. The material is not specifically limited as long as the material absorbs the organic solvent. Taking the case of using methyl acetate as a main solvent of the macromolecular solution 67 as an example, the support film is preferably made of cellulose acylate.

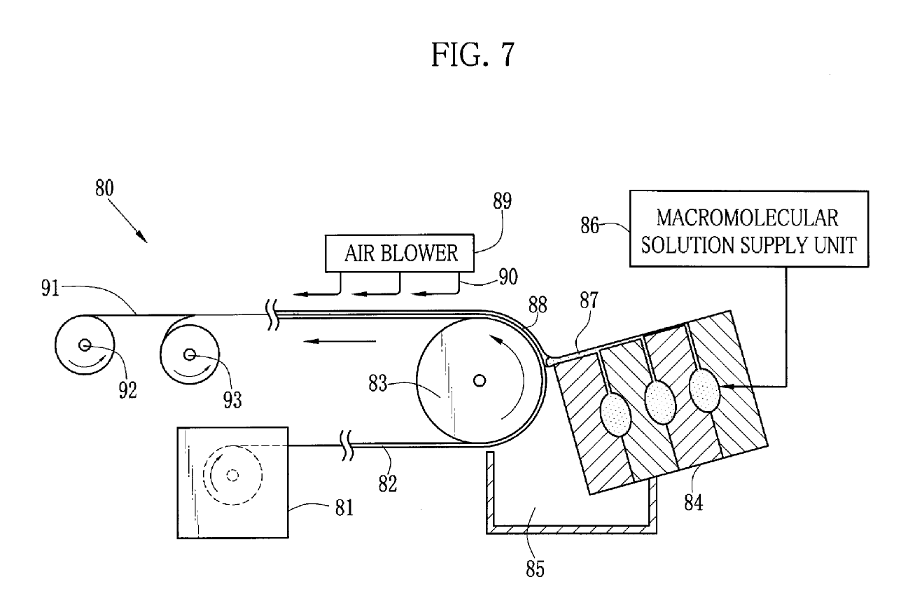

FIG. 7 shows a film manufacturing apparatus 80 according to further another embodiment used in a film manufacturing method of the present invention. Description of the same components as those of the film manufacturing apparatus 60 will be omitted. A support film feeder 81 feeds a support film 82 being a support material. The support film 82 is conveyed with being looped over a backup roller 83. In front of the backup roller 83, a multilayer slider coater 84 is disposed. The multilayer slide coater 84 has a decompression chamber 65. A macromolecular solution 87 that is conveyed from a macromolecular solution supply unit 86 by a pump is extruded from the multilayer slide coater 84, and applied onto the support film 82 being the support material to form a macromolecular film 88. The macromolecular film 88 formed on the support film 82 is subjected to the condensation and drying step 11 in which an air blower 89 blows air 90 on the macromolecular film 88. After completion of the condensation and drying step 11, a honeycomb structure film 91 is wound into a roll 92. The support film 82 is also wound into a roll 93.

Casting the multilayer macromolecular solution 87 onto the support film 82 makes it possible to vary the shape, the properties and the like of the honeycomb structure film 91 in a thickness direction.

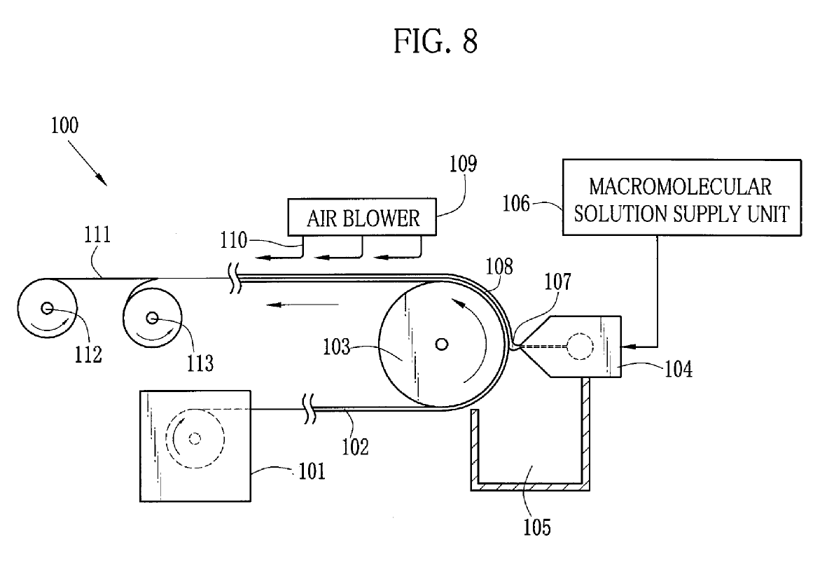

FIG. 8 shows a film manufacturing apparatus 100 according to further another embodiment used in the film manufacturing method of the present invention. Description of the same components as those of the film manufacturing apparatus 60 will be omitted. A support film feeder 101 feeds a support film 102 being a support material. The support film 102 is conveyed with being looped over a backup roller 103. In front of the backup roller 103, an extrusion coater 104 is disposed. The extrusion coater 104 has a decompression chamber 105. A macromolecular solution 107 that is conveyed from a macromolecular solution supply unit 106 by a pump is extruded from the extrusion coater 104, and applied onto the support film 102 being the support material to form a macromolecular film 108. The macromolecular film 108 formed on the support film 102 is subjected to the condensation and drying step 11 in which an air blower 109 blows air 110 on the macromolecular film 108. After completion of the condensation and drying step 11, a honeycomb structure film 111 is wound into a roll 112. The support film 102 is also wound into a roll 113.

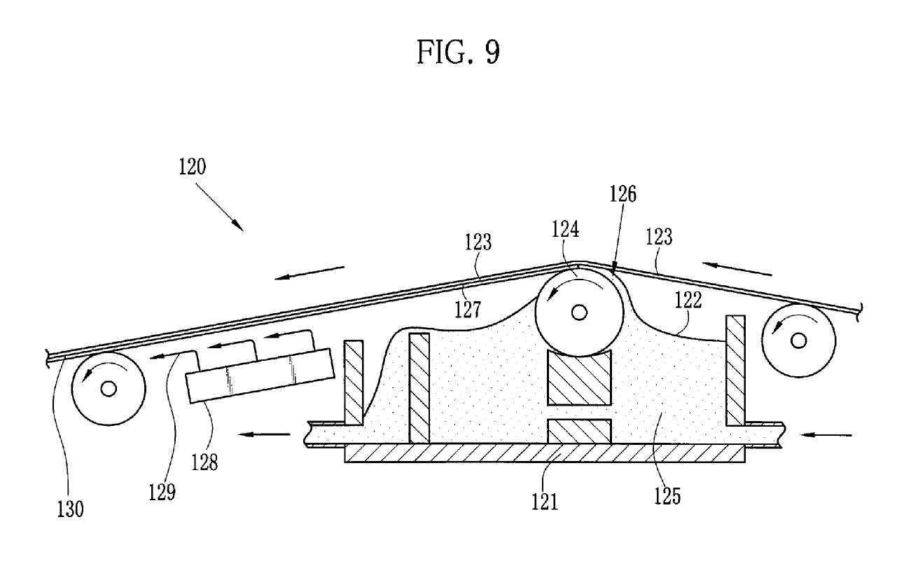

FIG. 9 shows a film manufacturing apparatus 120 for manufacturing a film according to the present invention. The present invention, however, is not limited to this embodiment, and a batch application, a continuous application, or an intermittent application for intermittently applying a macromolecular solution may be used instead. A wire bar coater 121 applies a macromolecular solution 122 onto a support film 123. A wire bar 124, which rotates in a conveyance direction of the support film 123 moving at constant speed, lifts a macromolecular solution 122 from a first macromolecular solution tank 125 to a liquid reservoir section 126 by its rotation. Since the macromolecular solution 122 in the liquid reservoir section 126 makes contact with the support film 123 on the wire bar 124, a macromolecular film 127 with uniform thickness is formed. The macromolecular film 127 is subjected to the condensation and drying step 11 in which an air blower 128 blows air 129 on the macromolecular film 127, and a honeycomb structure film 130 can be obtained. According to a method for manufacturing the honeycomb structure film 130 by using the wire bar 124, the liquid reservoir section 126 keeps air out of the a contact section between the macromolecular solution 122 and the film 123, and hence there is an advantage that an air bubble is hard to trap in the macromolecular film 127.

In the case of using the support film 62, 82, 102 or 123 as the support material, a combination film into which the honeycomb structure film 71, 91, 111 or 130 and the support material are integrated may be wound up for use.

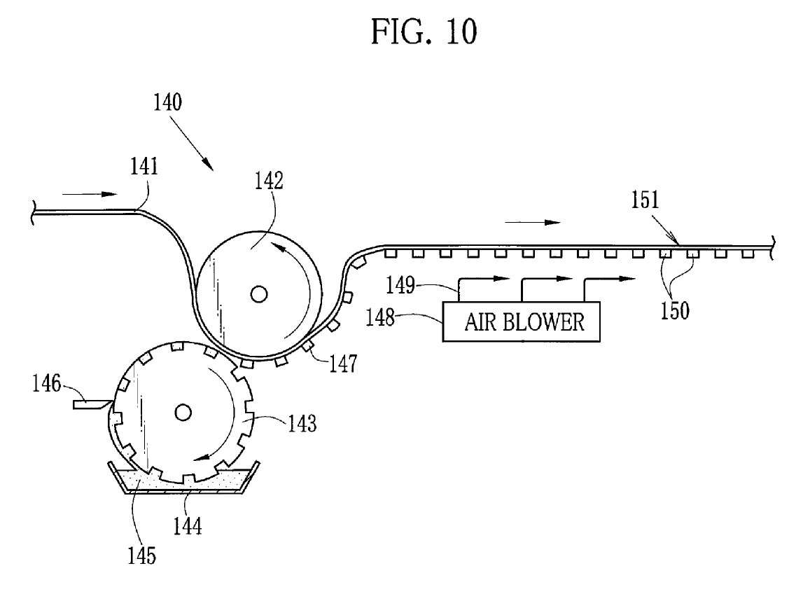

FIG. 10 shows a manufacturing apparatus 140 for manufacturing a film according to the present invention. A support film 141 is conveyed with being looped over an impression cylinder 142. Oppositely to the impression cylinder 142, a transfer cylinder 143 is disposed. A desired pattern is formed on the periphery of the transfer cylinder. A macromolecular solution 145 in a macromolecular solution tank 144 is deposited in recessed sections by rotation of the transfer cylinder 143. A doctor blade 146 scrapes the excessive macromolecular solution 145. After that, the macromolecular solution 145 is transferred onto the support film 141 that is traveling with being looped over the impression cylinder 142, and a macromolecular film 147 is formed.

The macromolecular film 147 is subjected to the condensation and drying step 11 with use of an air blower 148. The air blower 148 blows air 149 that is a parallel flow in the same direction as a conveyance direction of the support film 141. By undergoing the condensation and drying step 11, the macromolecular film 147 becomes a honeycomb structure section 150. Accordingly, a combination film 151 is formed into which the support film 141 and the honeycomb structure sections 150 having the desired pattern are integrated. The macromolecular solution 145 is intermittently applied in this embodiment.

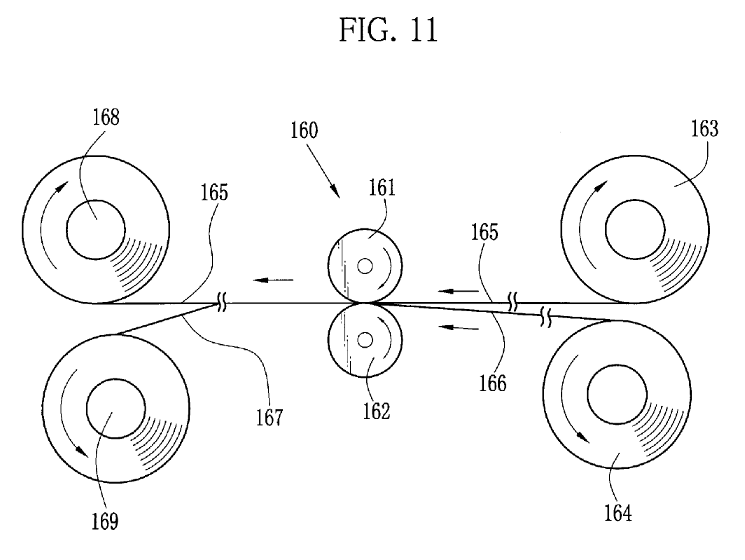

FIG. 11 shows a schematic view of a pressing device 160, and is described a method for manufacturing a film having projections arranged in a surface with use of a honeycomb structure film as a template. The pressing device 160 has press rollers 161 and 162. A honeycomb structure film 165 is drawn out of a honeycomb structure film roll 163, and a print film 166 is drawn out of a print film roll 164. Then, by use of the honeycomb structure film 165 having bumps and pits as the template, the pressing device 160 transfers a pattern of the honeycomb structure film 165 to the print film 166 to obtain a so-called moth-eye structure film 167 having the projections arranged in a surface. At this time, the honeycomb structure film 165 is preferably sucked by negative pressure on the opposite of a transfer surface in order to certainly transfer the pattern.

It is also preferable to use a hardening-processed honeycomb structure film or a metal-evaporated honeycomb structure film, instead of the honeycomb structure film 165.

Then, the honeycomb structure film 165 and the print film 167 having the projections in the surface are wound into rolls 168 and 169, respectively. The moth-eye structure film 167 has structure similar to a micro lens array film or a moth's eye in its size and shape, and has an antireflection function or the like. In the moth-eye structure film 167, the projections have a bottom pitch of from 0.1 μm to 0.3 μm, and a height of substantially from 0.5 to 2 times of a bottom side.

The film manufactured by the method of the present invention may be manufactured on a desired support material from the beginning to be used as-is, or may be soaked in an appropriate solvent such as ethanol and peeled from a support material used in manufacture and then disposed on a desired substrate for use. In the case of using the film after peeling, an adhesive including an epoxy resin or a silane coupler may be used for the purpose of increasing adhesion with the renewed substrate.

(2) Anther Process

The honeycomb structure film, the combination film, and the moth-eye structure film manufactured by the above methods can become functional films having further another function by being subjected to a function adding process. For example, impalpable particles that are small in size and have large refractive index difference from the film may be added to the film to obtain functionality. A function adding process may be carried out after manufacture of the honeycomb structure film, or during the manufacture of the honeycomb structure film.

The impalpable particles include, for example, light emitting particles by photoexcitation, electrical conductiveness or the like, magnetic particles that gets magnetism and is kept magnetized by light irradiation, a magnetic field or the like, and particles selectively bonded to or chemically react with a coloring ball or a microcapsule, or a living body component such as protein, sugar, DNA or the like.

The light emitting particles by the photoexcitation or the electrical conductiveness include, for example, organic pigment, organic dye, and a luminescent rare earth compound. A functional film containing such impalpable particles is usable for producing a photonic crystal, or as a luminescent material for a laser, an optical waveguide, a flat panel display or the like.

A functional film containing the impalpable particles that gets magnetism and is kept magnetized by the light irradiation or the magnetic field is usable as, for example, a recording or memory material.

A functional film containing the coloring ball or the microcapsule is usable as, for example, a paper-like display.

A functional film containing the impalpable particles that are selectively bonded to or chemically react with the living body component such as protein, sugar or DNA is usable as a biochip or a cell culture material.

Practical examples of the present invention will be hereinafter described, but the present invention is not limited to the following examples.

### Experiments 1 to 7 and Comparative Experiment 1

In an experiment 1, the following amphiphilic compound, fluorine surface active agent, and polymer were used as materials for the macromolecular solution 21 casted onto the casting belt. It was confirmed on analysis by atomic absorption spectrometry that the aforementioned fluorine atom-containing polymer contained a fluorine atom.

Amphiphilic compound: Polyalkylacrylamide having a ratio between the number of hydrophilic groups and the number of hydrophobic groups of 2.5:7.5 molecular weight, and a number-average molecular weight of approximately fifty thousand.

Fluorine surface-active agent: MEGAFACE F-781 made by DIC Corporation.

Polymer: cellulose triacetate (TAC) or cyclic polyolefin was used. In table 1, “P-1” indicates a case where the TAC was used.

Air compressor SC-820 made by Hitachi Koki Co., Ltd. having a commercially available air filter (with filter pores of 0.3 μm) was connected to a humidity generator made by Yamato Scientific Co., Ltd. in order to regulate the cleanliness and the humidity of air blown out of the air blower 34 and the dryer 36.

The surface tension of the aforementioned macromolecular solution 21 in which the fluorine atom-containing polymer was added was measured by a full automatic surface tensiometer CBVP-Z made by Kyowa Interface Science Co., Ltd. This value is described in a “surface tension” column of the table 1.

An electrification characteristic was measured to evaluate the degree of adhesion of dust to the film 12. This was carried out by measurement of surface resistivity based on JIS K 7194 “testing method for resistivity of conductive plastics with a four-point probe array”. As an index of electrification, a surface resistivity (Ω/sq.) is preferably less than 1.0×10¹³. If the surface reactivity is 1.0×10¹³ or more, it is said that the dust tends to adhere.

The degree of adhesion of the dust was evaluated by a method in which after ash of a cigarette was sprinkled on the film 12 and an air blower lightly blows air thereon, an amount of cigarette ash adhered was visually evaluated. A result is shown in a “dust adhesion” column of the table 1. In the table 1, “good” and “poor” mean as follows:

“Good”: the cigarette ash did not adhere.

“Poor”: the cigarette ash adhered.

The uniformity of the thickness of the obtained film 12 was evaluated. Since a nonuniform pore size causes a nonuniform thickness, evaluating the uniformity of the thickness can lead to evaluating the uniformity of the pore size. If the pore size is uniform, the film 12 can find widespread application. An evaluation result is shown in the table 1. In the table 1, “good” and “poor” mean as follows:

“Good”: thickness variation is ±15% or less with respect to an average of the thickness.

“Poor”: thickness variation is larger than ±15% with respect to the average of the thickness.

Furthermore, the uniformity of the microporous structure of the obtained film 12 was evaluated. This is because there is a case where an arrangement of the pores is disorderly, even if the pore size is uniform. In addition to the uniformity of the pore size, if the arrangement of the pores is orderly, the film 12 can find furthermore widespread application. The orderliness of the pore arrangement was evaluated in a diffraction experiment by laser scattering. A result is shown in a “porous structure uniformity” column of the table 1. In the table 1, “very good”, “good”, “average” and “poor” mean as follows:

“Very good”: a diffraction spot was clearly recognized.

“Good”: a diffraction spot was recognized.

“Average”: a diffraction pattern had multiple rings.

“Poor”: a diffraction pattern was not recognized.

Experiments 2 to 7 and a comparative experiment 1 were carried out with substitution of polymer components, an additive rate of the surface-active agent, or the like. The comparative experiment 1 is an experiment for comparison with the present invention, and the surface-active agent is not used therein. The table 1 shows conditions of the experiments 1 to 7 and the comparative experiment 1. In a “polymer” column of the table 1, “P-2” indicates cyclic polyolefin.

TABLE 1

| | | | | | Comp. | | | |
|---|---|---|---|---|---|---|---|---|
| | Ex. 1 | Ex. 2 | Ex. 3 | Ex. 4 | Ex. 1 | Ex. 5 | Ex. 6 | Ex. 7 |
| Polymer | P-1 | P-1 | P-1 | P-1 | P-1 | P-2 | P-2 | P-2 |
| Amphiphilic | 5 | 5 | 5 | 0 | 5 | 10 | 10 | 10 |
| Compound | | | | | | | | |
| (wt %) | | | | | | | | |
| Surface- | 0.1 | 1 | 8 | 1 | 0 | 0.01 | 10 | 1 |
| active | | | | | | | | |
| Agent | | | | | | | | |
| (wt %) | | | | | | | | |
| Surface | 21 | 20 | 19 | 20 | 27 | 24 | 18 | 20 |
| Tension | | | | | | | | |
| (mN/m) | | | | | | | | |
| Air Speed | 0.3 | 0.3 | 0.3 | 0.3 | 0.3 | 0.1 | 0.1 | 10 |
| (m/s) | | | | | | | | |
| Dust | Good | Good | Good | Good | Poor | Good | Good | Good |
| Adhesion | | | | | | | | |
| Thickness | Good | Good | Good | Good | Poor | Good | Good | Good |
| Uniformity | | | | | | | | |
| Porous | Very | Good | Aver- | Aver- | Very | Very | Aver- | Poor |
| Structure | Good | | age | age | Good | Good | age | |
| Uniformity | | | | | | | | |

### INDUSTRIAL APPLICABILITY

The film of the present invention is resistant to dust adhesion, and has the uniform pores in size. In addition, the large film can be continuously or intermittently manufactured at high speed and low cost. Therefore, the film of the present invention favorably finds widespread application as an optical or electronic material, in a regenerative medical field or the like.

1. A film comprising:
a polymer body; and
micropores formed in the polymer body, a microporous structure of the polymer body with the micropores being obtained by an application liquid and a surface-active agent, the application liquid containing an organic solvent and a polymer, the surface active agent containing a fluorine atom and reducing a surface tension of the application liquid.

2. The film according to claim 1, wherein the surface-active agent is a fluorine atom-containing polymer made by polymerization of a fluoroaliphatic group-containing monomer.

3. The film according to claim 2, wherein the fluoroaliphatic group-containing monomer is represented by a following general formula (1): 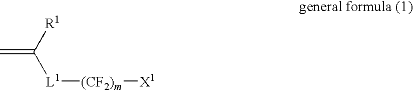
wherein, R¹ represents a hydrogen atom, a halogen atom, or a methyl group, L¹ represents a divalent linking group, m represents an integer between or equal to 1 and 12, and X¹ represents a fluorine atom or a hydrogen atom.

4. The film according to claim 1, wherein an additive amount of the surface-active agent is from 0.01 to 10 weight % of a total amount.

5. The film according to claim 2, wherein a mass-average molecular weight of the fluorine atom-containing polymer is from 2,000 to 100,000.

6. The film according to claim 1, wherein the polymer is at least one type of polymer chosen from a hydrophobic polymer and an amphiphilic polymer.

7. The film according to claim 6, wherein the hydrophobic polymer is at least one of cellulose triacetate, cellulose acetate propionate, and cyclic polyolefin.

8. The film according to claim 1, wherein the application liquid contains a polyfunctional monomer.

9. The film according to claim 1, wherein the microporous structure is a honeycomb porous structure made by self-organization.

10. A method for manufacturing a porous film comprising the steps of:
formulating an application liquid containing an organic solvent and a polymer;
adding a surface-active agent to the application liquid, the surface-active agent containing a fluorine atom and reducing a surface tension of the application liquid;
applying the application liquid onto a support material to form an applied film; and
forming pores in the applied film, by forming liquid drops in the applied film and evaporating the organic solvent and the liquid drops, to make the porous film.

11. The method according to claim 10, wherein a surface tension of the application liquid with the surface-active agent added is 25 mN/m or less.

12. The method according to claim 10, wherein in the pores forming step, the support material having the applied film is passed through a condensation zone to form the liquid drops, and 0° C.≦(TD1−TL)° C. is satisfied in the condensation zone, wherein TL(° C.) represents a surface temperature of the applied film, and TD1(° C.) represents a dew point.

13. The method according to claim 12, wherein air is blown in the condensation zone so that moisture in the air is condensed to form the liquid drops, and a relative speed between a blow speed of the air and a conveyance speed of the applied film is between or equal to 0.02 m/s and 2 m/s.

14. The method according to claim 12, wherein in the pores forming step, the support material having the applied film with the liquid drops formed is passed through a drying zone, and (TL−TD2)° C.≧1° C. is satisfied in the drying zone, wherein TD2(° C.) represents a dew point.
